(19) United States
(12) Patent Application Publication
(10) Pub. No.: US 2013/0017132 A1
(43) Pub. Date: Jan. 17, 2013

(54) REAGENT RESERVOIR AND THERMOCONDUCTIVE ADAPTOR

(71) Applicant: Brian Schryver, Redwood City, CA (US)

(72) Inventor: Brian Schryver, Redwood City, CA (US)

(73) Assignee: Biocision, Inc., Mill Valley, CA (US)

(21) Appl. No.: 13/548,022

(22) Filed: Jul. 12, 2012

Related U.S. Application Data
(60) Provisional application No. 61/507,036, filed on Jul. 12, 2011.

(51) Int. Cl. B01L 3/00; B01L 9/00

(52) U.S. Cl. 422/547; 422/560

(57) ABSTRACT

A thermoconductive reservoir device and adaptor.

### RELATED APPLICATIONS

This application claims priority to U.S. Provisional Patent Application Ser. No. 61/507,036, entitled REAGENT RESERVOIR AND THERMOCONDUCTIVE ADAPTOR, filed on Jul. 12, 2011, which is incorporated herein by reference in its entirety.

### BACKGROUND

In laboratory research, scientists frequently use reagent reservoirs to store reagents that are pipetted into sample containers for purposes of conducting experiments. Often, these reagents need to be maintained at a temperature close to 0 degrees C., so these reagent reservoirs are frequently placed on ice. A number of companies sell plastic reagent reservoirs for these purposes. See, for example, the reagent reservoirs marketed under catalog numbers SR-0050 and SR-0100 by Biotix Holdings (CA USA).

These commercially available reagent reservoirs, which may be termed “troughs” herein, and are commonly called “pipetting reservoirs,” are thin plastic shells (see Biotix website, for example), typically with a V-shaped interior to facilitate the uptake and dispensation of fluids by means of pipette, including a multichannel pipette. The reservoirs may be easily used for room temperature or pre-chilled fluids, but for many applications, it would be preferable to maintain the fluids in the reservoir at a constant (usually chilled, and often at near to 0° Celsius) temperature. While the commercially available troughs can be placed directly on crushed ice, the limited contact restricts heat transfer, and the ice is in any event an unstable platform, leading to frequent spillage and contamination of the reagent in the trough.

### BRIEF SUMMARY OF THE INVENTION

The present invention provides adaptors for the currently available troughs that provide both a stable base and excellent heat transfer from the trough to a cooling medium or cold (or heat) sink. Typical cold sinks include crushed ice, the ThermalTray™ product marketed by BioCision LLC (Mill Valley, Calif.), and cooling cartridges. The devices of the invention are made of thermoconductive materials with heat transfer properties much better than plastic. Suitable thermoconductive materials have thermal conductivity values (k) measured at 68° Fahrenheit of at least 25, and optionally of at least 50 or even at least 100 Btu/(hr degrees F. ft). In various embodiments, the adaptors are made from a metal or metal alloy, including but not limited to aluminum, i.e., anodized aluminum, copper, and aluminum alloys.

### SUMMARY OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. These drawings depict only typical embodiments of the invention and are not therefore to be considered to limit the scope of the invention.

FIG. 1 is a perspective view of a trough in accordance with a representative embodiment of the present invention.

FIG. 2 is a perspective view of an adaptor in accordance with a representative embodiment of the present invention.

FIG. 3, shown in parts A and B, is a perspective view of an adaptor and a disposable trough in accordance with a representative embodiment of the present invention.

### DETAILED DESCRIPTION OF THE INVENTION

Embodiments of the present invention will be best understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

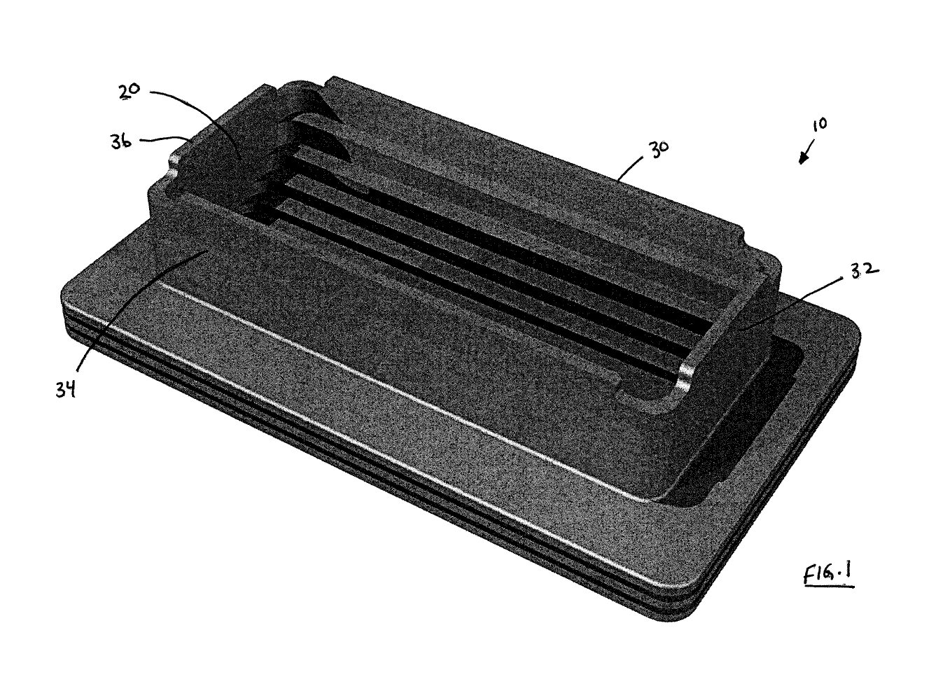

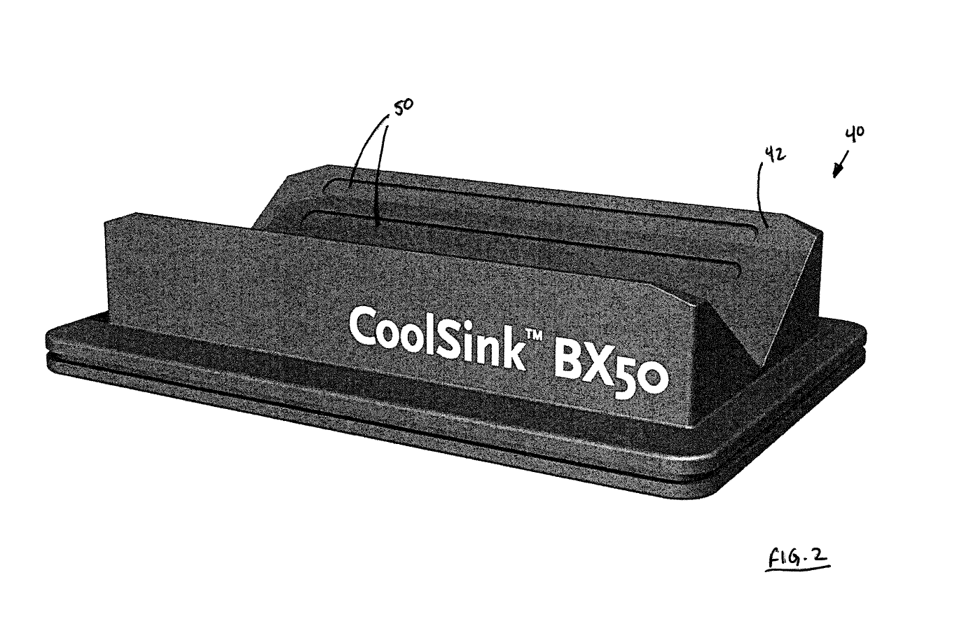

FIG. 1 shows a trough 10 or reservoir of the present invention. While the trough 10 can optionally have the V-shaped reservoir common to the currently available troughs, FIG. 1 shows an embodiment in which the liquid containing depression 20 of the trough is surrounded by four walls 30, 32, 34 and 36 of the adaptor allowing a space between the adaptor (not shown) and the trough 10 to be filled with a liquid such as water, thereby increasing thermal conduction. This embodiment is useful as an adaptor for troughs that feature complex contours and/or surface protrusions that interfere with surface mating of the adaptor to the underside of the trough. In addition, in some embodiments of the present invention in which the material of the adaptor is non-reactive (such as passivated aluminum alloy or any thermoconductive material coated with a non-reactive material, such as polyethylene or polypropylene), the adaptor is used directly as a trough, i.e., without the use of a disposable plastic trough insert or cover. The trough reservoir may be of any convenient size. For example, in some embodiments a trough reservoir is provide in various sizes that contain about 25 mL, about 50 mL, and about 100 mL of fluid.

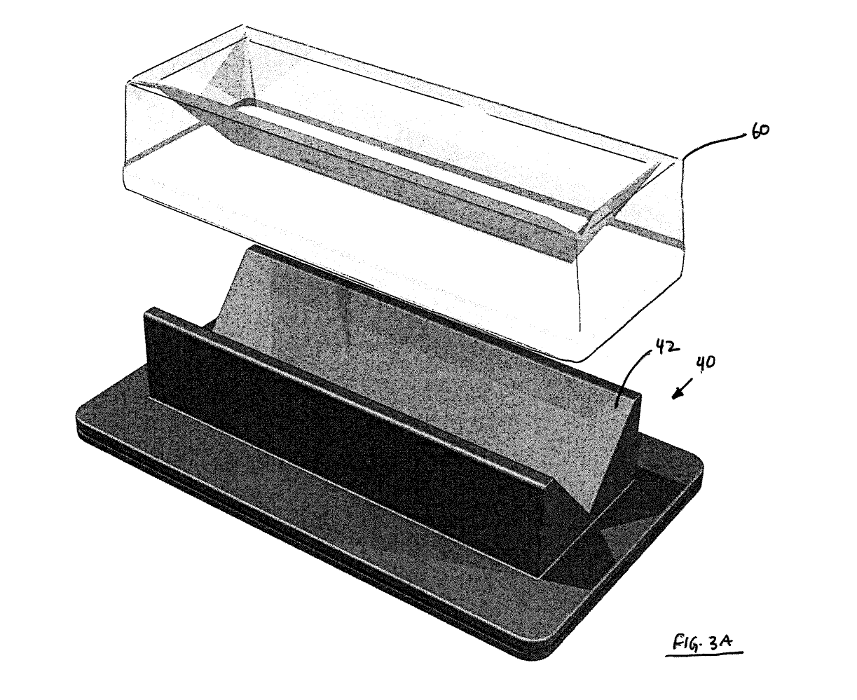

FIG. 2 shows an adaptor 40 of the invention, termed the CoolSink™ BX50 model that is designed to interface with commercially available reagent reservoirs, such as those marketed by Biotix (not shown). The adaptor surface 42 that is in contact with a plastic trough or reagent reservoir may contain any number and shape of depressions 50 or relief excavations that will allow maximum surface contact of the adaptor and the trough by accommodating molded-in surface deformations (such as liquid level lines and number markings) that are frequently present in commercially available troughs, and would otherwise interfere with surface mating of the trough to the adaptor 40. The adaptor 40 shown in FIG. 2 provides an example of two such relief depressions 50 in the adaptor mating surface 42.

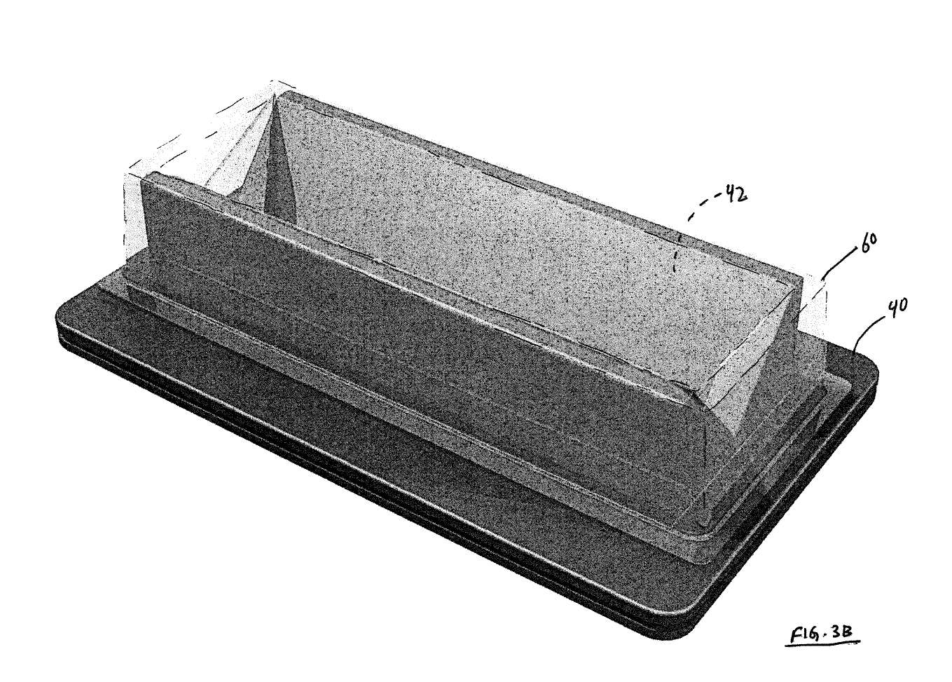

FIG. 3, in parts A and B, shows how the plastic, commercially available trough 60 nests into the adaptor 40. FIG. 3A shows that trough 60 comprises a surface that is configured to nest over adaptor 40 thereby providing close contact between the sides and mating surface 42 of adaptor 40, as shown in FIG. 3B. In some embodiments, this close contact is desirable to maintain efficient heat transfer between adaptor 40 and a fluid inserted within trough 60.

While the troughs and adaptors of the invention provide a superior means to maintain fluids and reagents at 0° C. or lower when placed on ice or other chilled materials, those of skill in the art will readily appreciate in view of this disclosure that one can also use them to maintain reagents at higher temperatures. For example, the troughs and adaptors can be placed on a warm surface, such as a heating plate, or in a warmed reservoir of liquid, such as a waterbath.

The troughs and adaptors of the invention perform very well in tests and are capable of maintaining the reservoir contents at 0.5 to 1 degrees C. using ice as a cooling medium or cold sink. For example, in some embodiments the adaptor is placed onto a bed of ice or other cooling medium (such as dry ice, liquid nitrogen, alcohol slurries, water baths, etc.). Heat from the cooling medium is transferred through the adaptor and into a fluid or reagent stored within the adaptor. In instances where the adaptor further comprises a trough, heat from the cooling medium is additionally transferred through the trough and into a fluid or reagent stored within the trough.

There are a number of “laboratory reservoir coolers” that are gel based plastic cooling modules currently on the market. The troughs and adaptors of the present invention are far superior to these in that they are highly thermoconductive, while gels degrade in performance as they are used due to an increasing boundary of thawed gel which acts as an insulator barrier. In addition, freezing gels can distort the plastic outer shell thereby impairing thermal contact. Another advantage of the adaptors of the present invention is that the duty cycle may be extended indefinitely by simply refreshing the cold source.

The adaptors and troughs of various embodiments of the invention are sized to fit conveniently in containers typically used as ice buckets in laboratories. For example, a suitable trough or adaptor can have a base this is about 5 to 7 inches long and about 3 to 4.5 inches wide, with a height of about 1 to 1.5 inches. In one embodiment, the base is 5.2 inches long and 3.5 inches wide, and the height is 1.12 inches. This size allows the reservoir to hold up to about 100 mL of fluid. The adaptors and troughs of the invention can be readily manufactured by machining from solid metal stock. The adaptors and troughs can also be manufactured by casting from metal, i.e., sand, investment, or slip casting.

The following patent applications are incorporated herein by reference: U.S. Patent Application Pub. Nos. 2009/0098583; 2009/0173472; and 2009/0258407; PCT Patent Application No. US2011/040757; and U.S. Patent Application Ser. Nos. 61/460,091; 61/466,795; and 61/487,445.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A reagent trough as described herein.

2. The reagent trough of claim 1 with a shape as shown in FIG. 1.

3. An adaptor for a reagent trough as described herein.

4. The adaptor of claim 3 with a shape as shown in FIGS. 2 and 3.
